(19) United States
(12) Patent Application Publication
(10) Pub. No.: US 2009/0060631 A1
(43) Pub. Date: Mar. 5, 2009

(54) RING BINDER MECHANISM WITH POLYMERIC HOUSING AND TRAVEL BAR

(75) Inventors: Chun Yuen To, Hong Kong (CN); Jin Biao Pi, Daye City (CN); Ming Hua Huang, Sui Zhou City (CN)

Correspondence Address: SENNIGER POWERS LLP, 100 NORTH BROADWAY, 17TH FLOOR, ST LOUIS, MO, 63102, US

(73) Assignee: WORLD WIDE STATIONERY MFG. CO., LTD., Hong Kong (CN)

(21) Appl. No.: 11/852,006

(22) Filed: Sep. 7, 2007

Related U.S. Application Data
(60) Provisional application No. 60/969,403, filed on Aug. 31, 2007.

(51) Int. Cl. B42F 13/20

(52) U.S. Cl. 402/38; 402/73

(57) ABSTRACT

A ring binder mechanism has an elongate housing constructed of a polymeric material. The housing has a central portion and lateral sides extending downwardly along either side thereof. A ring support is disposed between the lateral sides and is supported thereby for movement relative to the housing. Each of a plurality of rings includes first and second ring members. The first ring member is mounted on the ring support for movement between a closed position and an open position. The mechanism includes a control structure movable relative to the housing. The control structure is adapted to releasably lock the first member in the closed position by blocking movement of the ring support. The control structure comprises a travel bar moveable in translation relative to the housing. The travel bar includes a locking element for engagement with the ring support to block movement of the ring support.

### CROSS REFERENCE TO RELATED APPLICATION

This application claims priority to U.S. provisional application Ser. No. 60/969,403, filed Aug. 31, 2007, the contents of which are hereby incorporated by reference.

### FIELD OF THE INVENTION

This invention relates to a ring binder mechanism for retaining loose-leaf pages, and in particular to a ring binder mechanism having a housing constructed at least in part from a polymeric material.

### BACKGROUND

A ring binder mechanism retains loose-leaf pages, such as hole-punched pages, in a file or notebook. It has ring members for retaining the pages. The ring members may be selectively opened to add or remove pages or closed to retain pages while allowing the pages to be moved along the ring members. The ring members mount on two adjacent hinge plates that join together about a pivot axis.

A housing—typically metal and elongated—loosely supports the hinge plates within the housing and holds the hinge plates together so they may pivot relative to the housing. The housing has a generally arch-shaped cross-section, with bent-under rims that hold the hinge plates within the housing. The hinge plates are disposed within and extend across the open bottom part of the arch spaced from the top wall of the arch and the ring members extend through notches or openings in the housing.

The undeformed housing is narrower than the joined hinge plates when the hinge plates are in a coplanar position (180°). So as the hinge plates pivot through this position, they deform the resilient housing laterally outwardly and cause a spring force in the housing that urges the hinge plates to pivot away from the coplanar position, either opening or closing the ring members. Thus, when the ring members are closed the spring force resists hinge plate movement and clamps the ring members together. Similarly, when the ring members are open, the spring force holds them apart. An operator may typically overcome this force by manually pulling the ring members apart or pushing them together. Levers may also be provided on one or both ends of the housing for moving the ring members between the open and closed positions.

Some ring mechanisms include locking structure(s) that block hinge plates from pivoting when the ring members are closed. The locking structure positively locks the closed ring members together, preventing them unintentionally opening if the ring mechanism is accidentally dropped. For example, locking structures can be incorporated on a control slide moveable relative to the housing between a locking position in which locking elements on the control slide block pivoting movement of the hinge plates and non-locking position in which the locking elements do not block movement of the hinge plates.

Conventionally, the housing is mounted on the file or notebook with the open bottom part of the housing facing the file or notebook. Thus, the hinge plates are covered by the top wall of the housing. This configuration presents a generally solid metal surface as the exposed surface of the housing.

This exposed surface often has a nickel-containing plating, to which some people may be sensitive. Additionally, it is difficult and/or more costly to print on a metal surface—particularly where the metal surface is nickel-plated—in a manner that the printing is retained on the surface. Nickel plating can also present some environmental and work hazard issues in manufacturing of the ring binder mechanisms.

### SUMMARY OF THE INVENTION

In one aspect, the present invention is a ring binder mechanism for holding loose-leaf pages. The mechanism generally includes an elongate housing constructed of a polymeric material. The housing has a central portion and lateral sides extending downwardly along either side of the central portion. A ring support is disposed between the lateral sides of the polymeric housing and supported thereby for movement relative to the housing. The mechanism also includes a plurality of rings for holding the loose-leaf pages. Each ring includes a first ring member and a second ring member. The first ring member is mounted on the ring support for movement with the ring support relative to the housing between a closed position and an open position. In the closed position the first and second ring members form a substantially continuous, closed loop for allowing loose-leaf pages retained by the rings to be moved along the rings from one ring member to the other. In the open position the first and second ring members forming a discontinuous, open loop for adding or removing loose-leaf pages from the rings. A control structure is movable relative to the housing for producing the movement of the ring support. The control structure is adapted to releasably lock the first member in the closed position by blocking movement of the ring support that moves the ring members to said opened position. The control structure includes a travel bar moveable in translation relative to the housing. The travel bar includes a locking element for engagement with the ring support to block movement of the ring support.

Other features will be in part apparent and in part pointed out hereinafter.

### BRIEF DESCRIPTION OF THE DRAWINGS

FIG. 1 is a perspective of one embodiment of a ring binder mechanism of the present invention mounted on a notebook;

FIG. 2 is an enlarged perspective of the ring binder mechanism shown in FIG. 1;

FIG. 3 is an enlarged perspective of the ring binder mechanism shown in FIGS. 1-2 from a vantage point from which the bottom of the mechanism is visible;

FIGS. 4 & 5 are enlarged perspectives of the ring binder mechanism shown in FIGS. 1-3, similar to FIGS. 2 and 3, respectively, except that the rings are in their open position;

FIG. 6 is an exploded perspective view of the ring binder mechanism shown in FIGS. 1-5;

FIG. 6A is a side elevation of a travel bar of the ring binder mechanism;

FIG. 7 is a side elevation of the ring binder mechanism shown in FIGS. 1-6;

FIG. 8 is a top plan view of the ring binder mechanism shown in FIGS. 1-7;

FIG. 9 is a bottom plan view of the ring binder mechanism shown in FIGS. 1-8;

FIG. 10 is a perspective of a housing of the ring binder mechanism shown in FIGS. 1-9;

FIG. 11 is another perspective of the housing shown in FIG. 10 from a vantage point from which the bottom of the housing is visible;

FIG. 12 is a bottom plan view of the housing shown in FIGS. 10-11;

FIG. 13 is an enlarged cross section of a portion of the ring binder mechanism shown in FIGS. 1-9 taken in a plane including line 13-13 on FIG. 8;

FIG. 13A is a cross section similar to FIG. 13, but showing the ring binder mechanism moving from an open toward a closed position;

FIG. 14 is an enlarged cross section of the ring binder mechanism shown in FIGS. 1-9 and 13 taken in a plane including line 14-14 on FIG. 8;

FIG. 15 is a cross section similar to FIG. 14 except that the rings are in their open position;

FIG. 16 is cross section of the housing shown in FIGS. 10-12;

FIG. 17 is a perspective of a second embodiment of ring binder mechanism of the present invention;

FIG. 18 is a bottom plan view of the ring binder mechanism shown in FIG. 17;

FIG. 19 is a perspective of a travel bar of the ring binder mechanism shown in FIGS. 17-18;

FIGS. 20 and 21 are cross sections of the ring binder mechanism shown in FIGS. 17-18 taken in a plane including line 20-20 on FIG. 18 illustrating rings thereof in closed and open positions, respectively;

FIG. 22 is an enlarged cross section of a portion the ring binder mechanism shown in FIGS. 17-18 and 20-21 taken in a plane including line 22-22 on FIG. 17;

FIG. 23 is a perspective of a third embodiment of a ring binder mechanism of the present invention;

FIG. 24 is a bottom plan view of the ring binder mechanism shown in FIG. 23;

FIG. 25 is a cross section of the ring binder mechanism shown in FIGS. 23 and 24 taken in a plane including line 25-25 on FIG. 24;

FIG. 26 is a perspective of a fourth embodiment of a ring binder mechanism of the present invention;

FIG. 27 is a bottom plan view of the ring binder mechanism shown in FIG. 26; and

FIG. 28 is a cross section of the ring binder mechanism shown in FIGS. 26 and 27 taken in a plane including line 28-28 on FIG. 27.

Corresponding reference numbers indicate corresponding parts throughout the views of the drawings.

### DETAILED DESCRIPTION

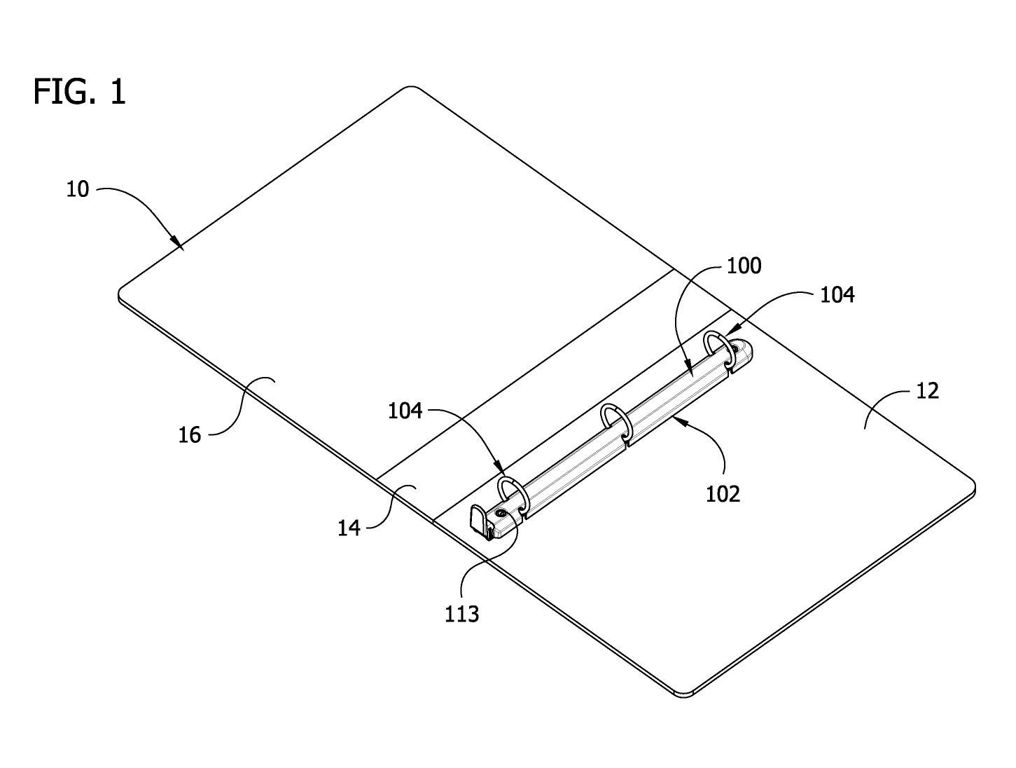

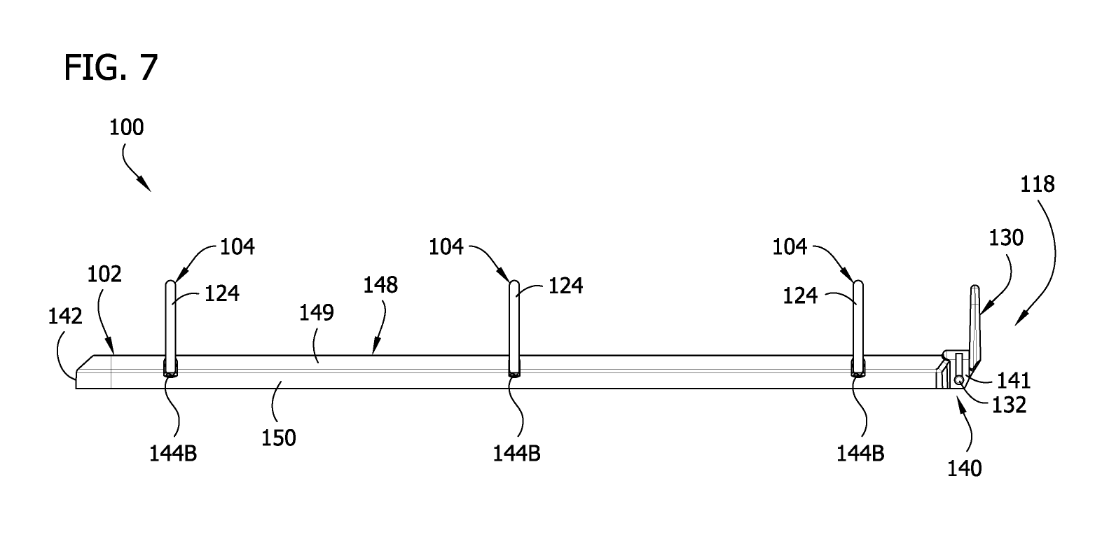

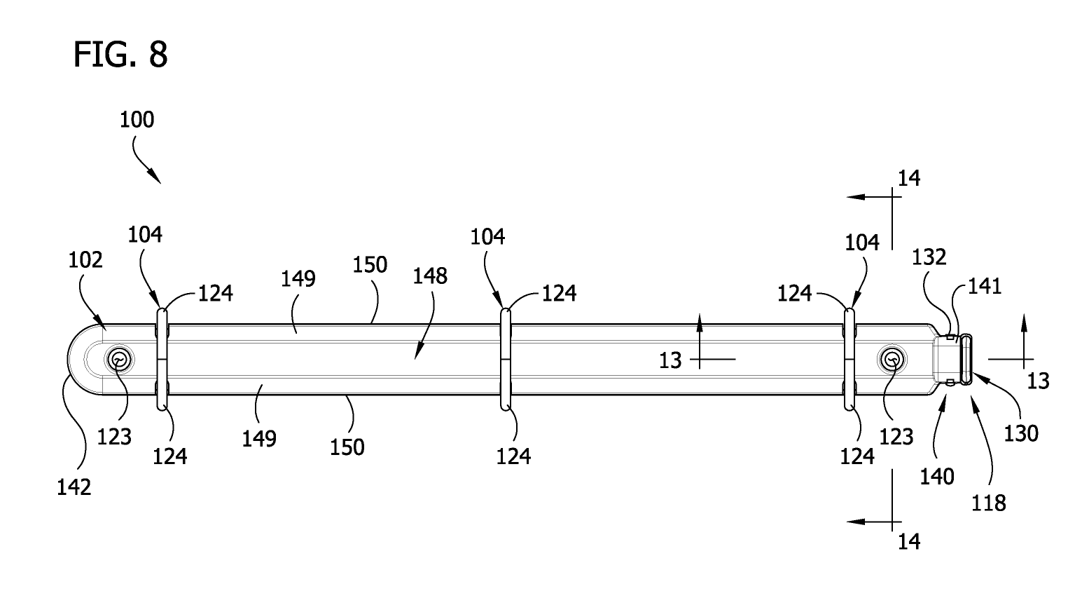

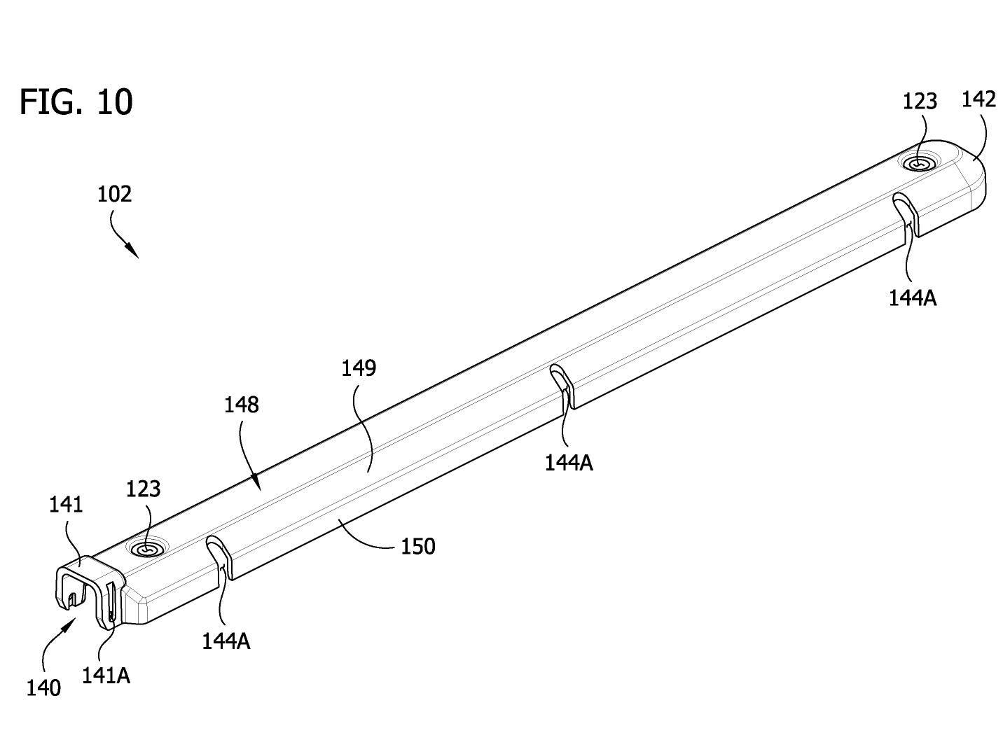

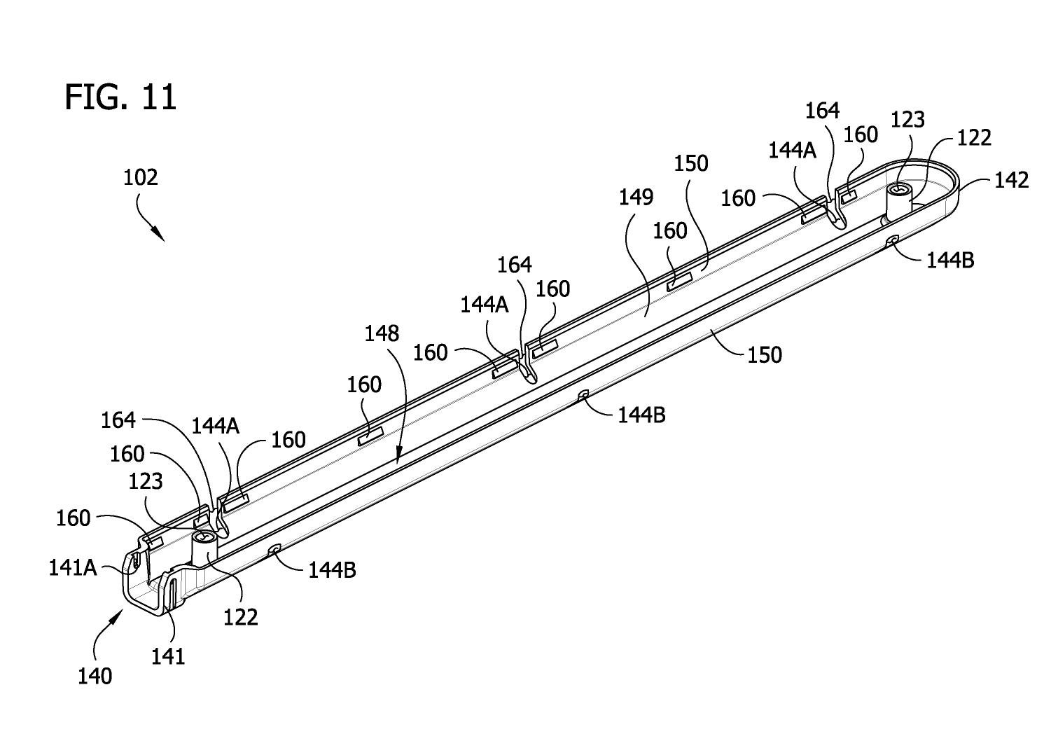

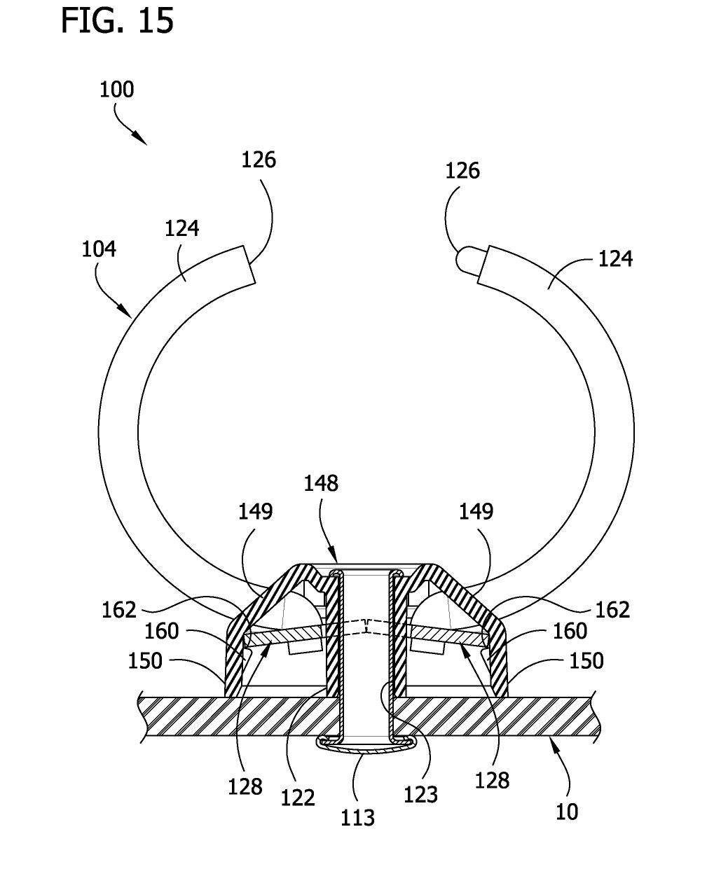

Referring to the drawings, FIGS. 1-16 illustrate one embodiment of a ring binder mechanism, generally indicated at 100. In FIG. 1, the mechanism 100 is shown mounted on a notebook designated generally at 10. Specifically, the mechanism 100 is shown mounted on the back cover 12 of the notebook 10 by means of rivets 113, generally adjacent to and aligned with the spine 14 of the notebook 10. The rivets 113 extend through attachment openings 123 at opposite ends of the housing 102. The front cover 16 of the notebook 10 is hingedly connected to the spine 14 and moves to selectively cover or expose loose-leaf pages (not shown) retained by the mechanism 100 in the notebook 10. Ring binder mechanisms mounted on notebooks in other ways (e.g., on the spine) or on surfaces other than a notebook (e.g., a file) do not depart from the scope of this invention. Ring binder mechanisms can also be in an unmounted state within the scope of the invention.

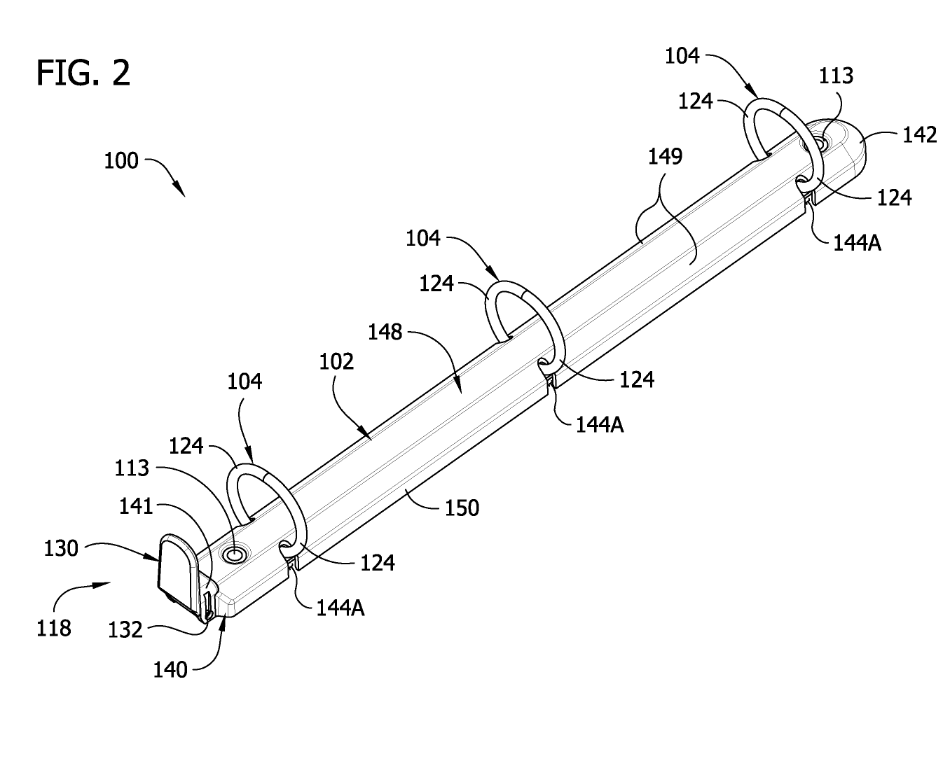

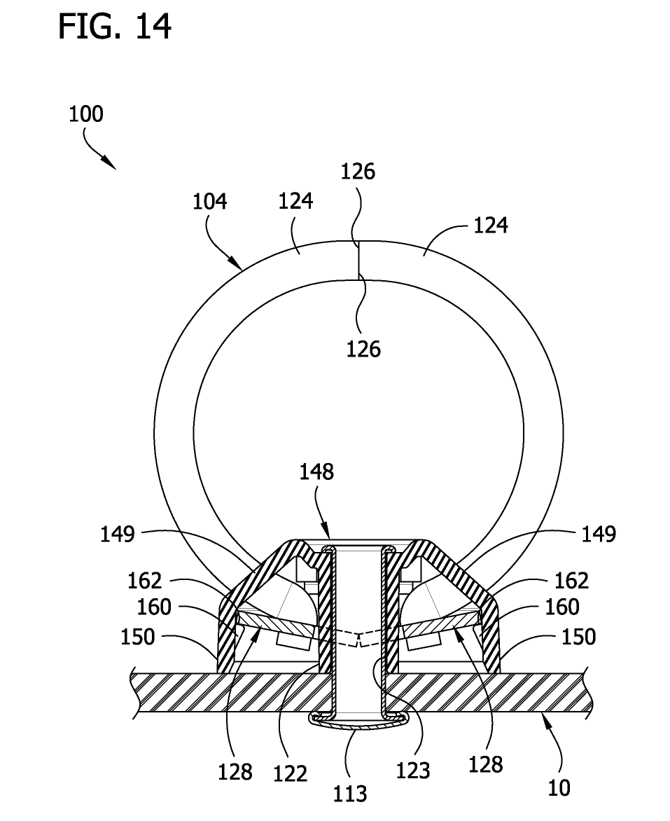

Referring to FIGS. 2-9, this embodiment of the mechanism 100 includes a housing, designated generally at 102, supporting a pair of hinge plates 128 (broadly a ring support) and two rings, each of which is designated generally at 104. The housing 102 has an elongate shape comprising a central portion 148 and lateral sides 150 extending downward in generally vertical planes along either side of the central portion generally between opposite longitudinal ends 140, 142 spaced the length of the housing from one another. In the embodiment shown in FIG. 1, the central portion has shoulders 149 that are sloped downward (e.g., at an angle of about 45 degrees) toward their intersection with the lateral sides 150. The arrangement of the central portion 148 and lateral sides 150 results in the housing having a generally concave cross-sectional configuration between the ends 140, 142, as illustrated in FIGS. 14-16.

One longitudinal end 140 of the housing 102 has a mounting formation 141 thereon for mounting an actuating lever 130 that is part of a control structure (generally indicated at 118) used to operate the mechanism 100, as described below. In the illustrated embodiment, the mounting formation 141 is a short longitudinally extending channel-shaped structure having opposing sides with respective openings 141A aligned with an axis transverse to the longitudinal axis of the housing for receiving metal pin 132 on which the actuating lever 130 is pivotally mounted. It is understood that other mounting formations are possible within the scope of the invention. The opposite longitudinal end 142 of the housing 102 is closed and rounded or blunt, which reduces the likelihood that objects, such as a user's hand or clothing, will be unintentionally caught on the end of the housing. Other end configurations, even including open configurations do not depart from the scope of the present invention. Attachment openings 123 for the rivets 113 or other means by which the housing 102 can be secured to the notebook 10 are defined proximate the ends 140, 142 of the housing 102. In the illustrated embodiment, for example, the attachment openings 123 extend through tubes 122 projecting downward from the central portion 148 of the housing 102.

One lateral side 150 of the housing 102 has a plurality of notches 144A defined therein extending down the lateral side all the way to its end. A plurality of openings 144B are defined in the housing 102 generally opposite the notches 144A (e.g., generally at the intersection of the opposite lateral side 150 and the central portion 148 of the housing 102). In contrast to the notches 144A, the openings 144B of this embodiment do not extend all the way to the bottom of the respective lateral side 150. The notches 144A and openings 144B are arranged in pairs. Each of the rings 104 comprises a pair of ring members 124, one ring member extending through one of the notches 144A and the other ring member extending through the corresponding opening 144B. The notches 144A facilitate assembly of the ring mechanism by allowing the ring member 124 that is to be received therein to slide upwardly into the housing and be received in the notch 144A without any rotation of the ring member. In comparison to the notches 144A, the use of openings 144B that do not extend all the way to the bottom of the lateral side 150 results in greater rigidity of the housing 102. It is understood that other combinations of notches and openings can be provided in the housing to receive the rings 104 (including all notches extending to the bottom of the lateral sides or all openings that do not extend all the way to the bottom of the lateral sides) without departing from the scope of the invention.

The housing 102 is constructed of a resilient polymeric material. In the illustrated embodiment the tubes 122 and mounting formation 141 are molded as one piece with the housing 102. However, these parts could be formed separately and attached to the housing. Acrylonitrile butadiene styrene (ABS) is one example of a suitable polymeric material in that it has been found by the present inventors to be particularly resistant to fatigue type failure and capable of withstanding numerous cycles of operation when used in construction of the housing as described herein. In one embodiment, the polymeric material has an impact strength of at least about 5 kJ/m². Because the housing 102 is constructed of a polymeric material it is readily fabricated in a variety of different colors, which is useful for color-coding notebooks. Additionally, printed text (either raised or imprinted) may be molded into or otherwise formed in the body if so desired. Further, the polymeric material does not require nickel plating (as is usually the case with metal housings for ring binders) and is therefore agreeable to people who are sensitive to nickel. The entire housing 102 is molded as a single unitary piece as is the case for embodiment illustrated in the drawings. However, the housing can include non-unitary features and can be manufactured in different ways, including by being constructed in multiple pieces that are later joined together to make the housing, without departing from the scope of the invention.

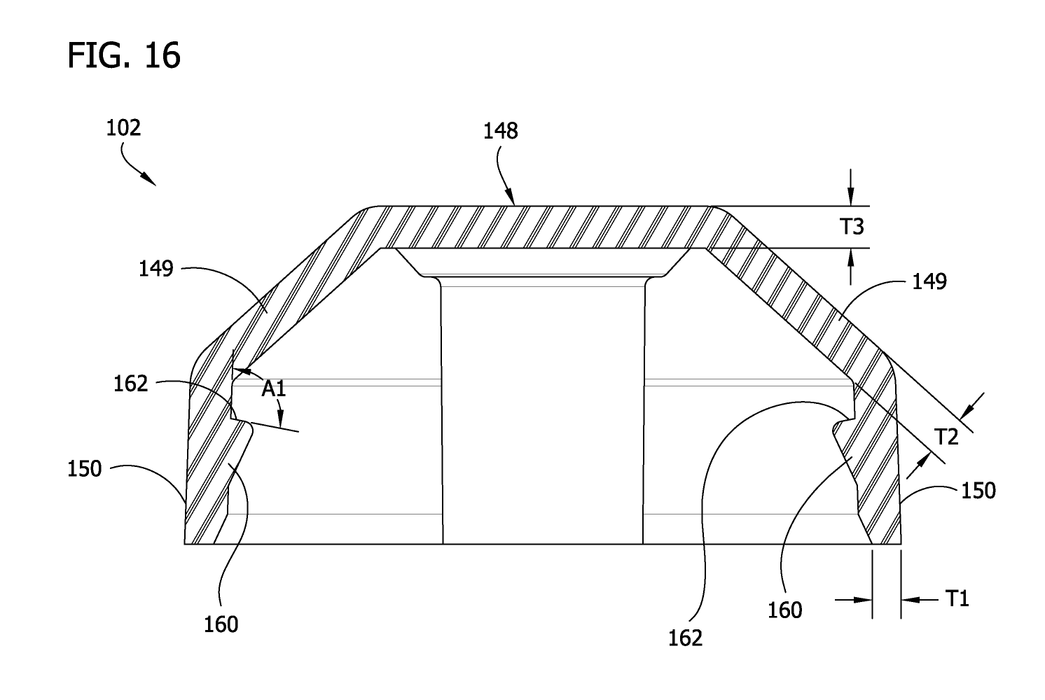

In the illustrated embodiment, the height of the housing 102 may be in the range of about 8.5 to 18.5 mm, and the width of the open bottom part of the housing may in the range of about 17 to 45 mm. In that event, the housing 102 may have average wall thicknesses, (e.g., the thickness T1 of the lateral sides 150, the thickness T2 of the shoulders 149, and the thickness T3 of the central portion 148 between the shoulders), which are each in the range of about 1.2 to about 1.8 mm (FIG. 16). The average wall thicknesses T1, T2, T3 of the lateral sides 150, the shoulders 149, and the central portion 148 between the shoulders, respectively, are about the same. In one embodiment of the invention, the wall thickness T1 of the lateral sides 150, the thickness T2 of the shoulders 149, and the thickness T3 of the central portion 148 between the shoulders are within a range of about 1.2 to about 1.8 mm over their entireties. In another embodiment, the wall thickness T1 of the lateral sides 150, the thickness T2 of the shoulders 149, and the thickness T3 of the central portion 148 between the shoulders are within a range of about 1.2 to about 1.8 mm and substantially uniform over their entireties.

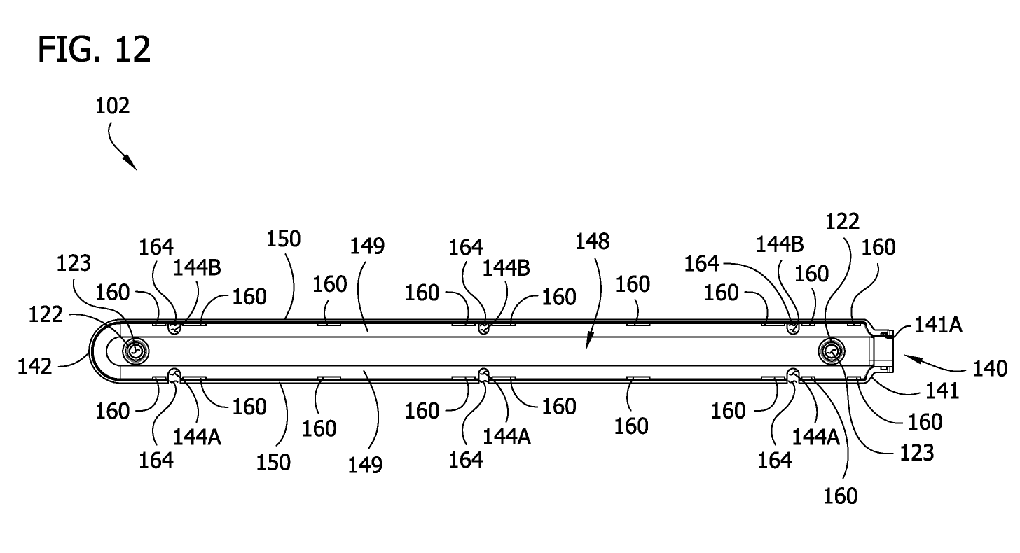

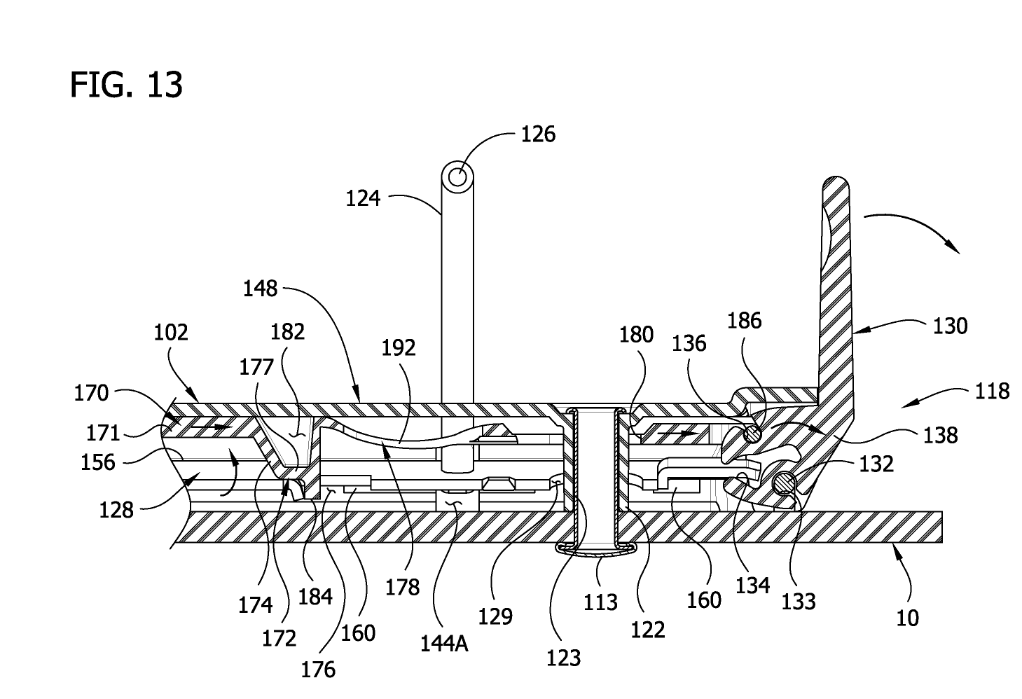

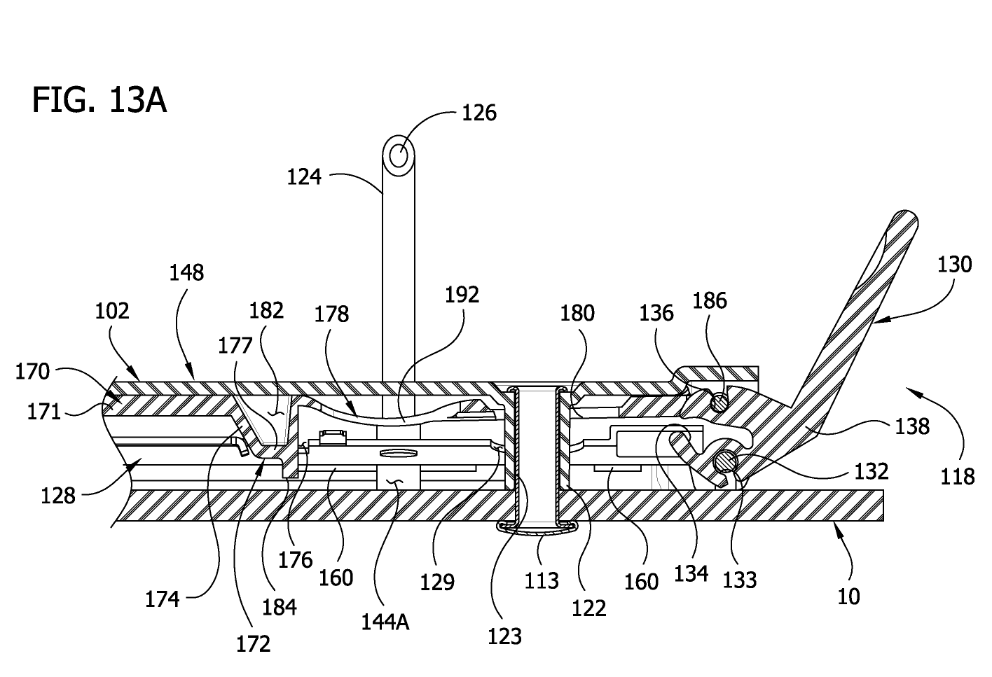

The lateral sides 150 of the undeformed housing 102 are spaced apart by a distance that is only very slightly less than the distance between the outer edge margins 156 of the interconnected hinge plates 128 when they are pivoted on the central hinge 154 to be coplanar with one another. Thus, deformation of the housing 102 associated with pivoting movement of the hinge plates 128 during operation is substantially minimized. For example in one configuration, the width of the open bottom part increases by only in the range of about 0.8 to 1.8 mm during opening. A plurality of hinge plate supports 160 project inwardly from the lateral sides 150 of the housing 102, as shown in FIG. 12. The hinge plate supports are molded as one piece with the lateral sides 150 of the housing 102. The hinge plate supports 160 are engageable with the outer edge margins 156 of the interconnected hinge plates 128 to retain the hinge plates in the housing 102 during operation of the ring binder mechanism 100. Referring to FIGS. 14-16, the hinge plate supports 160 of the illustrated embodiment are wedge-shaped formations defining support surfaces 162 extending transversely inward from the lateral sides 150 of the housing. The wedge-shaped hinge plate supports 160 taper from the support surface 162 in a direction away from the central portion 148 of the housing 102. The support surfaces 162 are nearly perpendicular to the lateral sides 150 of the housing. In one embodiment, the support surfaces 162 incline at least slightly downward extending inward from the lateral sides 150. In this embodiment, the support surfaces 162 and lateral sides 150 form an angle A1 (FIG. 13A) that is greater than 90 degrees (e.g., about 100 degrees). It is to be understood that angles between the support surface 162 and lateral sides 150 may be greater than 100 degrees within the scope of the present invention.

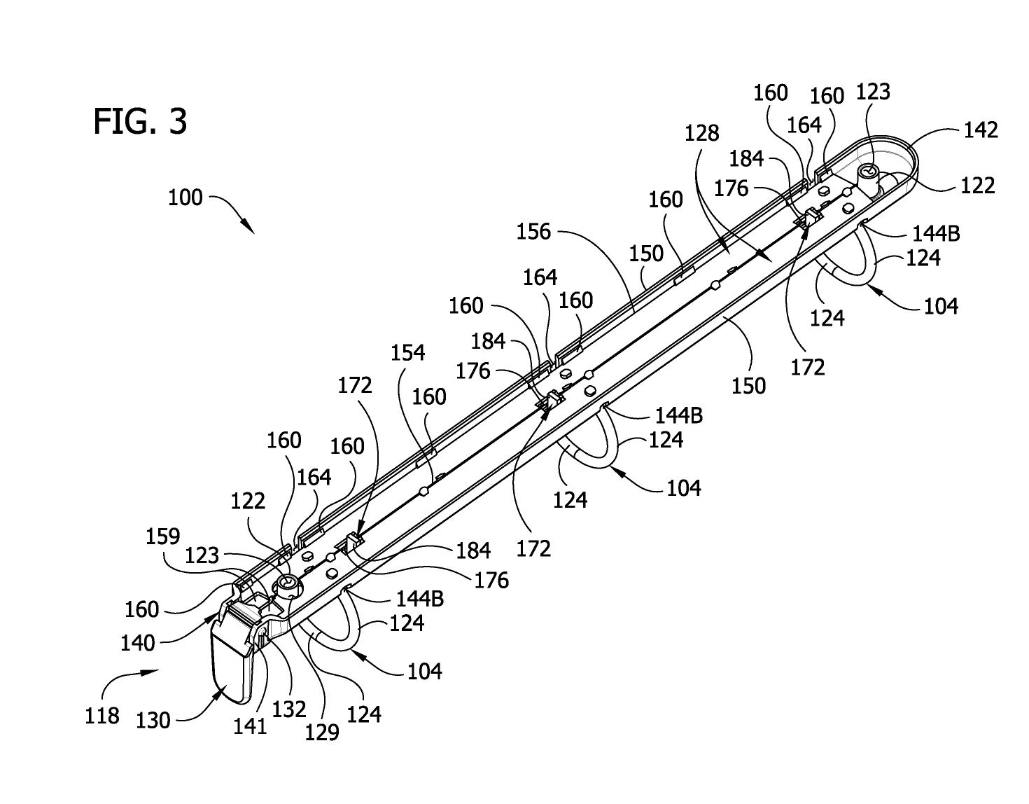

As illustrated in FIGS. 3, 5, 9, and 11, the hinge plate supports 160 of the illustrated embodiment include plural hinge plate supports on each lateral side 150 of the housing 102. The hinge plate supports 160 are distributed longitudinally along the housing 102. For example, in this embodiment, hinge plate supports 160 are suitably disposed adjacent the longitudinal ends 140, 142 of the housing as well adjacent each of the notches/openings 144A, 144B for the rings 104. In the illustrated embodiment, there are gaps 164 in coverage of the lateral sides 150 by hinge plate supports 160 aligned with the openings 144A, 144B for the rings 104 allowing the ring members 124 to pass through the gaps between hinge plate supports during assembly of the ring binder mechanism 100. Further, additional hinge plate supports 160 are disposed approximately midway between the rings 104. The construction of and number of hinge plate supports, the spacing between various adjacent hinge plate supports, and the longitudinal lengths of the hinge plate supports may vary within the scope of the invention.

As previously noted above, the ring support in this embodiment includes a pair of hinge plates 128, which are generally mirror images of one another. The hinge plates 128 are each generally elongate, flat, and rectangular in shape, and are each somewhat shorter in length than the housing 102, as shown in FIG. 3. The hinge plates 128 are interconnected in side-by-side arrangement along their inner longitudinal margins, forming a central hinge 154 having a pivot axis for pivoting movement of the hinge plates relative to one another. This is suitably done in a conventional manner known in the art. The interconnected hinge plates 128 are disposed between the lateral sides 150 of the housing 102 such that the outer edge margins 156 of the hinge plates engage the lateral sides above the hinge plate supports 160, which retain the interconnected hinge plates 128 in the housing. As will be described, pivoting movement of the hinge plates 128 in the housing 102 is accompanied by movement of the central hinge 154 upward and downward relative to the housing as well as pivoting movement of outer edge margins 156 of the hinge plates relative to lateral sides 150 of the housing.

The hinge plates 128 are short enough that they do not obstruct insertion of the rivet 113 adjacent the end 142 of the housing 102 opposite the actuating lever 130. At the other end 140 of the housing 102, the hinge plates define an opening 129 through which the tube 122 and rivet 113 that are adjacent the actuating lever 130 extend. The tubes 122 are engageable with the notebook 10 for supporting the housing 102. If desired other openings may be provided in the hinge plates in a similar manner to allow for use of additional rivets (e.g., near the midpoint between the ends 140, 142 of the housing) to connect the mechanism 100 to a notebook 10 or other structure.

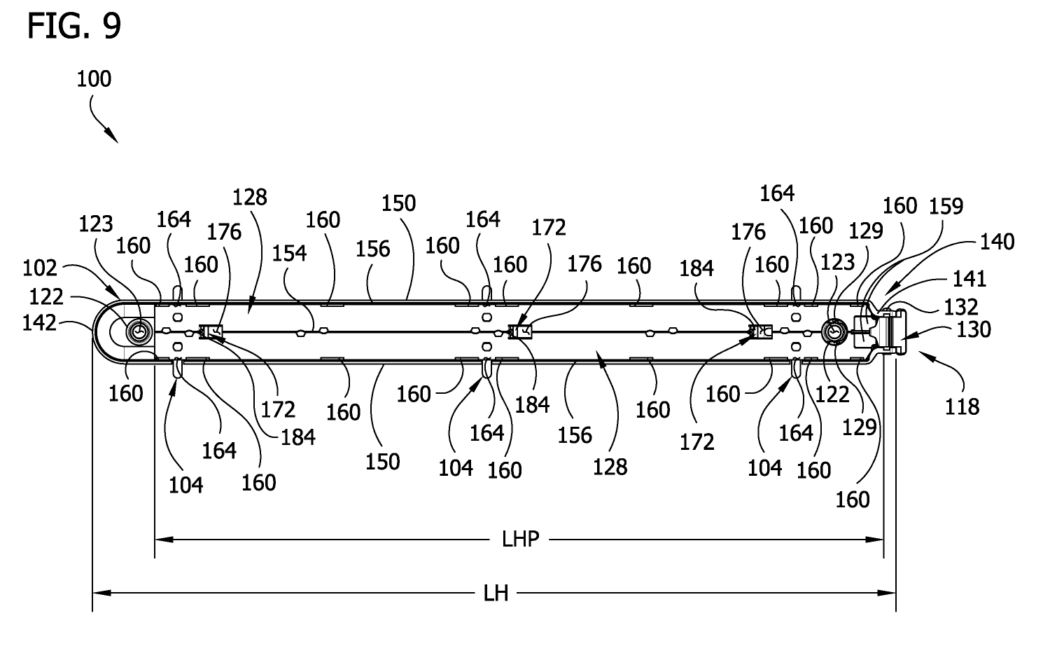

Although the hinge plates 128 of the illustrated embodiment are not a long as the housing 102, they have a length LHP that is greater than one half the length of the housing LH (FIG. 9). The hinge plates 128 are suitably constructed of a resilient metal (e.g., steel) having a thickness in the range of about 0.6 to 1.6 mm. The hinge plates 128 have substantially more rigidity than the housing 102. The rigidity of the hinge plates 128 facilitates efficient transfer of forces through the hinge plates (e.g., to facilitate transfer forces applied the hinge plates to open and/or close the rings).

The rings 104 retain loose-leaf pages (not shown) on the ring binder mechanism 100 in the notebook 10. The two rings 104 of the ring binder mechanism 100 are substantially similar and are each generally circular in shape. The rings 104 each include two generally semi-circular ring members 124 formed from a conventional, cylindrical rod of a suitable material (e.g., steel). The ring members 124 include free ends 126 that are formed to secure the ring members 124 against misalignment when they are closed together. The rings could be D-shaped as is known in the art, or shaped otherwise within the scope of this invention. Ring binder mechanisms with ring members formed of different material or having different cross-sectional shapes, for example, oval shapes, do not depart from the scope of this invention. Likewise the number of rings supported by the housing can vary within the scope of the invention.

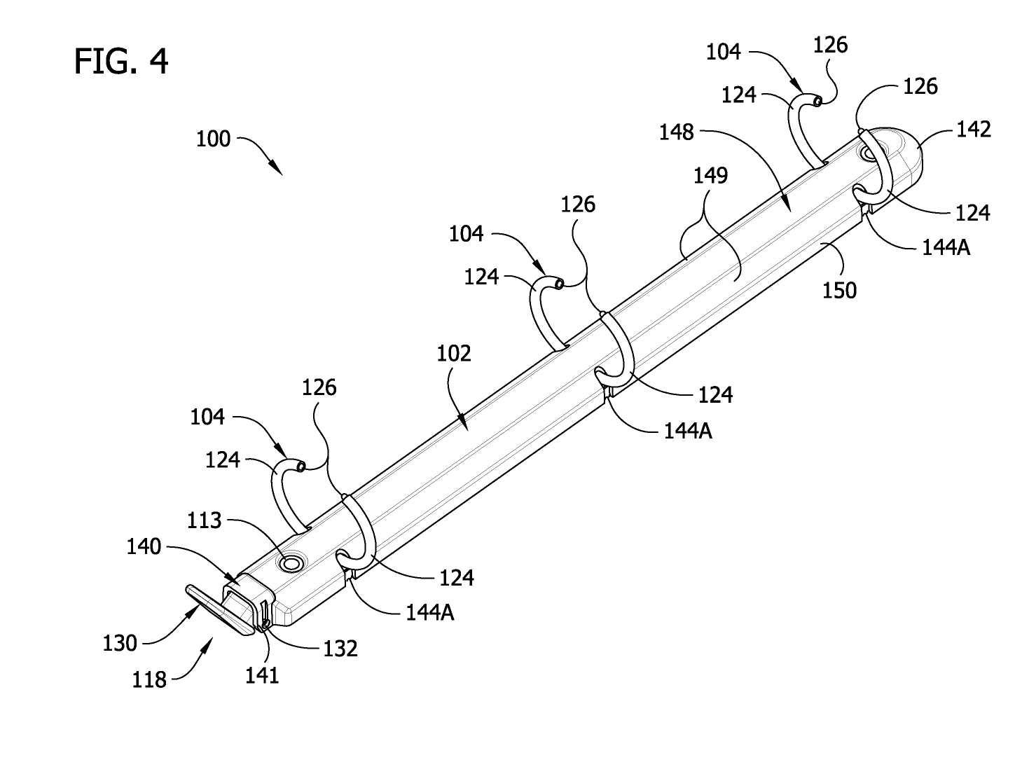

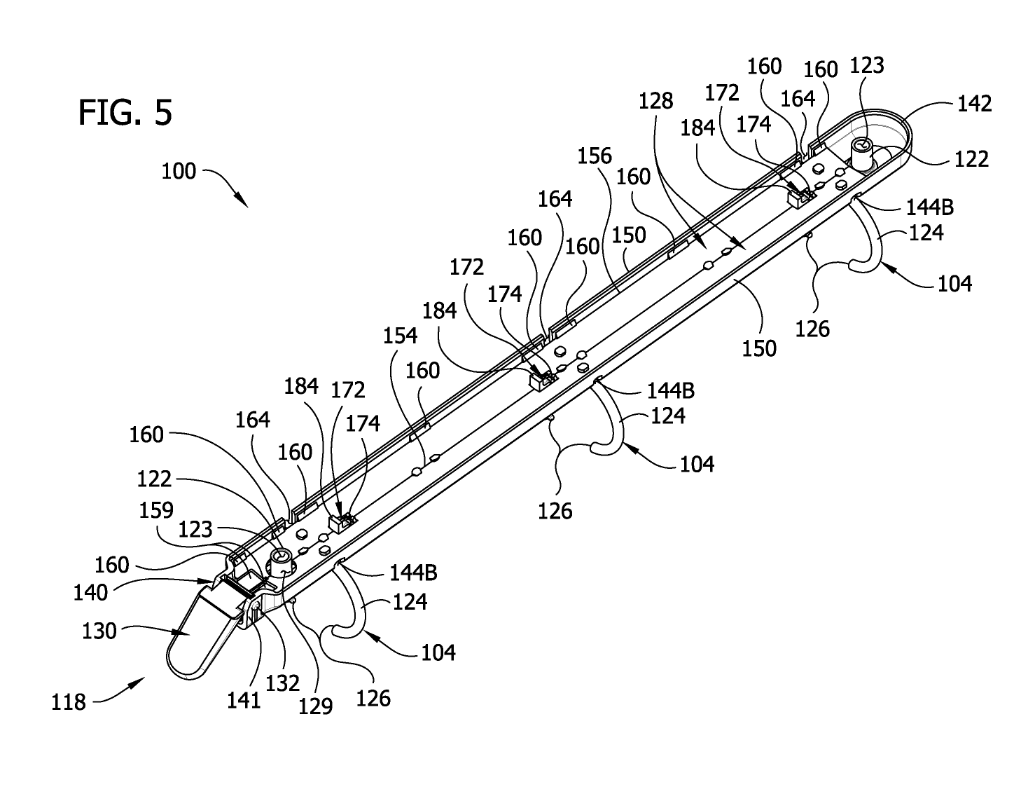

One ring member 124 of each ring 104 is mounted on one of the interconnected hinge plates 128, while the other ring member of that ring is mounted on the opposite hinge plate. The ring members 124 extend through respective notches/openings 144A, 144B and are arranged so their free ends 126 face toward one another above the housing 102. The ring members 124 are moveable between an open position (FIGS. 4 and 5) in which loose-leaf pages can be added to and/or removed from the ring binder mechanism 100 and a closed position (FIGS. 1-3) in which the free ends 126 of corresponding ring members 124 are joined to retain any loose-leaf pages then on the rings 104 in the binder mechanism.

In the illustrated embodiment, the ring members 124 are rigidly connected to the hinge plates 128 as is known in the art so the ring members move with the hinge plates when they pivot. Although in the illustrated ring binder mechanism 100 both ring members 124 of each ring 104 are each mounted on one of the two hinge plates 128 and move with the pivoting movement of the hinge plates 128, a mechanism in which each ring has one movable ring member and one fixed ring member does not depart from the scope of this invention (e.g., a mechanism in which only one of the ring members of each ring is mounted on a hinge plate with the other ring member mounted, for example, on the housing 102).

The control structure 118 is moveable relative to the housing 102 for producing movement of the hinge plates 128 (ring support). In the illustrated embodiment, the control structure 118 includes the actuating lever 130 and a travel bar 170 connected (e.g., by a direct pivoting connection as illustrated in FIG. 13) to the actuating lever for translation of the travel bar longitudinally in the housing 102 via the actuating lever 130. The actuating lever 130 of this embodiment defines a channel 133 into which the metal pin 132 received in openings 141A is snapped to mount the actuating lever 130 for pivotal movement of the lever relative to the housing by a user, as indicated by the arcuate arrows on FIG. 13. A handle 186 of the travel bar 170 is snapped into another channel 136 defined in the actuator so pivoting movement of the actuating lever 130 moves the travel bar 170 translationally generally lengthwise of the housing 102 (e.g., pulls it toward the actuating lever) as indicated by the horizontal arrows in FIG. 13.

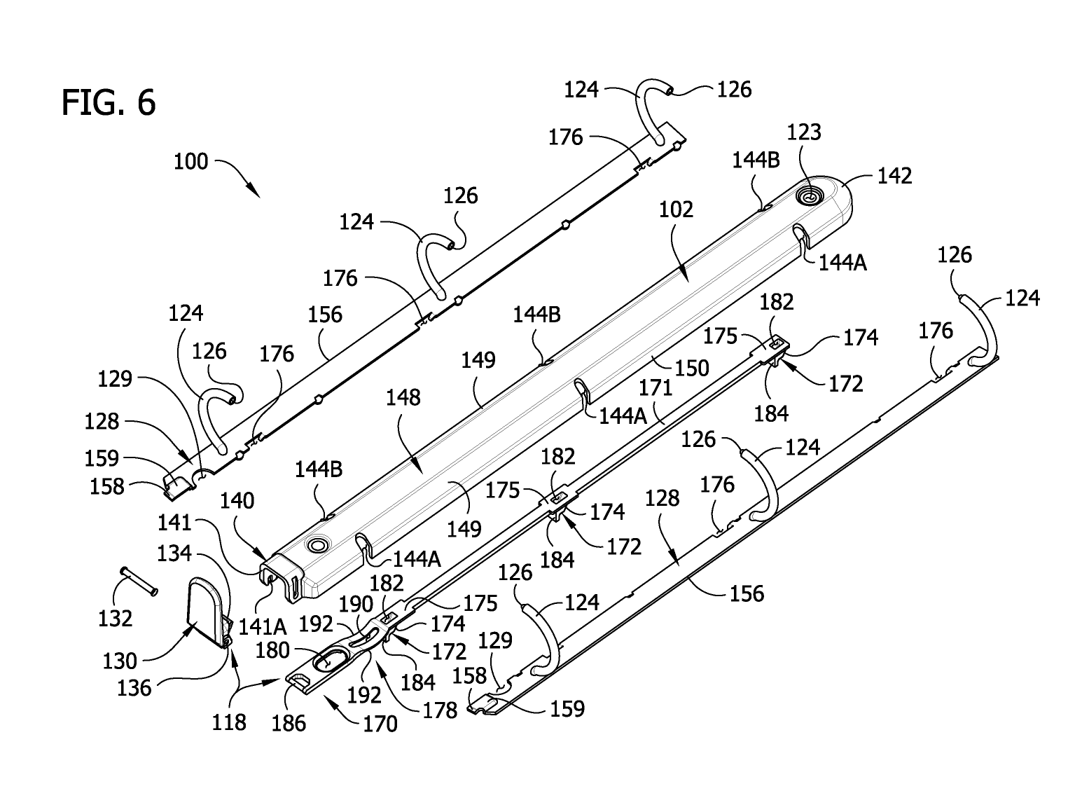

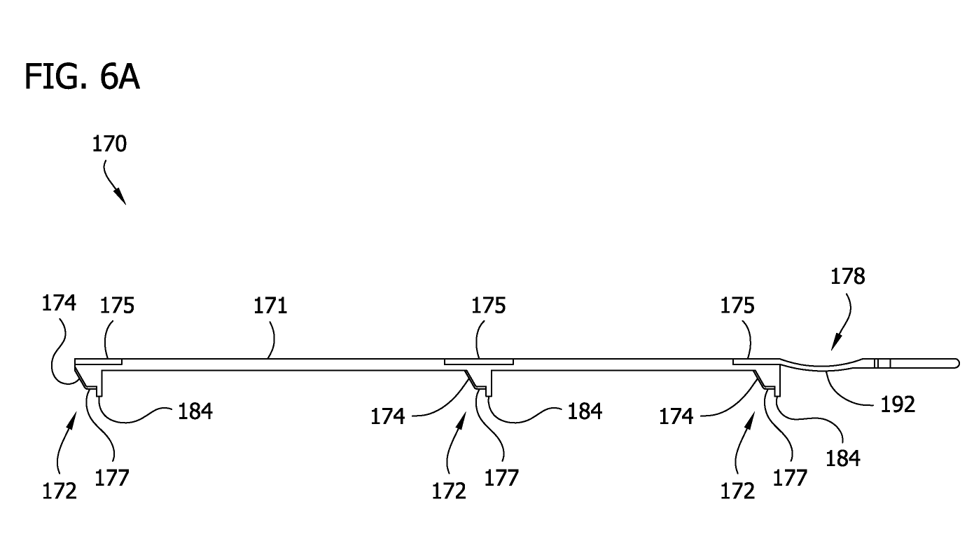

The control structure 118 is adapted to releasably lock the ring members 124, and therefore the rings 104, in their closed position by blocking movement of the hinge plates 128 needed to move them to their open position. As shown in to FIGS. 6 and 13, the travel bar 170 of this embodiment includes an elongate bar 171 extending a majority of the length of the travel bar 170 and a plurality of locking elements 172 thereon that engage the hinge plates 128 to block pivoting movement of the hinge plates to open the rings. The locking elements 172 of this embodiment include inclined shoulders 174, which extend away from the elongate bar 171 to a generally horizontal plateau 177 that engages the hinge plates 128 to block pivoting movement thereof when the travel bar 170 is positioned relative to the housing 102 as shown in FIG. 13. The locking members 172 also include tips 184 on the opposite side of the plateau 177 from the inclined shoulder 174.

As the travel bar 170 is moved by pivoting of the actuating lever 130, the plateaus 177 move into registration with openings 176 defined by the interconnected hinge plates 128 so that the plateau no longer blocks movement of the hinge plates. Pivoting movement of the actuating lever 130 also produces pivoting movement of the hinge plates 128 to move the rings 104 between their open and closed positions. As illustrated in FIGS. 3, 5, and 6, the hinge plates 128 of the illustrated embodiment comprise fingers 158 that are adjacent the central hinge 154 connecting the plates. The fingers 158 project longitudinally from the ends of the hinge plates 128 and are captured in a receptacle 134 defined in the actuating lever 130 so that forces applied to pivot the actuating lever are applied to the fingers of the hinge plates to raise and lower the fingers in the housing. The fingers 158 of this embodiment are included in parts 159 of the hinge plates 128 that are raised relative to other parts of the hinge plates (e.g., by stamping) to facilitate alignment of the fingers with the receptacle 134. As the fingers 158 of the hinge plates 128 are raised and lowered in the housing 102 by the actuating lever 130, the outer edge margins 156 of the interconnected hinge plates are loosely captured by the lateral sides 150 of the housing, thereby resulting in pivoting movement of the hinge plates relative to the housing.

It will be appreciated that movement of the travel bar 170 longitudinally has to precede pivoting movement of the hinge plates 128 during opening of the rings so the plateaus 177 are moved into registration with the openings 176 in the hinge plates before the hinge plates begin their pivoting movement. Likewise, the longitudinal movement of the travel bar 170 back to its closed position (FIG. 13) has to be preceded by movement of the hinge plates 128 back to their closed position. This sequencing of the movements of the hinge plates 128 and travel bar 170 is suitably accomplished by constructing one or more of the hinge plates 128, actuating lever 130, and travel bar 170 to provide lost motion during opening and/or closing of the rings 104. For example, one or more of the hinge plates 128, actuating lever 130, and travel bar 170 is constructed to deform while the elongate bar 171 moves longitudinally in the housing to delay pivoting movement of the hinge plates 128 until after the plateaus 177 are in registration with the openings 176.

The actuating lever 130 of this embodiment, for example, is constructed to have a living hinge 138 (FIG. 13) that facilitates deformation of the actuating lever so that the movement of the receptacle 134 that has captured the fingers 158 of the hinge plates 128 may lag behind movement of the channel 136 that has captured the handle 186 of the travel bar 170 during opening of the rings 104. Similarly, the living hinge 138 facilitates deformation of the actuating lever upon closing of the rings 104 so that movement of the channel 136 that has captured the handle 186 of the travel bar 170 may lag behind movement of the receptacle 134 that has captured the fingers 158 of the hinge plates.

The travel bar 170 of this embodiment also includes a hinge region 178 disposed between the elongate bar 171 and handle 186 thereof. The hinge region 178 facilitates deformation of the travel bar 170 to allow movement of the elongate bar 171 to lag behind movement of the handle 186 during closing of the rings 104 to sequence movement of the locking members 172 and the hinge plates 128. The hinge region 178 is also adapted to bend about an axis transverse to the elongate bar 171.

Although there are various ways to construct a suitable hinge region within the scope of the invention, the hinge region 178 of the illustrated embodiment has a thickness that is less than the thickness of the travel bar 170 on opposite ends thereof, as illustrated in FIG. 13. Further, the hinge region 178 is curved in a direction lengthwise of the travel bar 170, and the hinge region curves away from the central portion 148 of housing 102. Moreover, as illustrated in FIG. 6, the hinge region 178 defines an elongate opening 190 between two thin lateral arms 192 extending between opposite ends of the hinge region that facilitates bending of the hinge region.

A plurality of pads 175, each of which has a transverse width greater than a transverse width of the elongate bar 171, are spaced along the elongate bar and disposed for slidably engaging the housing 102 (e.g., the underside of the central portion 148 of the housing). The locking elements 172 of the illustrated embodiment are disposed along the elongate bar 171 at positions coinciding with the positions of the pads 175. Because the width of the pads 175 is greater than the elongate bar 171, the pads increase the resistance of the travel bar 170 to twisting motion (e.g., in response to an attempt to open the rings 104 while the locking elements 172 are positioned to block movement of the hinge plates 128). The pads 175 also distribute loads encountered when the locking elements 172 block pivoting motion of the hinge plates 128 over a wider area of the housing central portion 148.

The actuating lever 130 and/or travel bar 170 are constructed of a polymeric material. For example, the actuating lever 130 and/or travel bar can be constructed of the same (or similar) polymeric material as the housing 102. In one embodiment, the actuating lever 130 and travel bar 170 are both made of either Nylon or Polyoxymethylene (POM). The locking elements 172 of the illustrated embodiment are integrally formed as one piece with the rest of the travel bar 170. Voids 182 are optionally included in the locking elements 172 (e.g., to facilitate use of various molding processes to make the travel bar 170.) However, locking elements may be made separately and attached to the travel bar within the scope of the invention.

When the mechanism 100 is at rest, the ring members 124 and hinge plates 128 are normally at either their closed position (FIG. 13). In this position, the locking elements 172 block movement of the hinge plates 128 and thereby hold the rings 104 in the closed position. Because the locking elements 172 block movement of the hinge plates 128 in this position, there is no need for the housing 102 to provide a substantial spring force to hold the rings 104 in the closed position.

Referring to FIG. 13, when a user pivots the actuating lever 130 in the direction of the arrows, the travel bar 170 is pulled toward the actuating lever by arcuate movement of the channel 136 carrying the handle 186 of the travel bar. The hinge plates 128 and/or actuating lever 130 deform to allow the plateaus 177 of the locking elements 172 to move into registration with respective openings 176, thereby allowing pivoting movement of the hinge plates in the direction of the arrow on FIG. 13 (and the ring members 124) away from the closed position. The actuating lever 130 deforms under initial resistance of the locking elements 172 by deformation of the living hinge 138 so that upward pivoting movement of the hinge plates 128 is delayed while the travel bar 170 moves the locking elements 172 into the openings 176.

Likewise, to close the rings 104, the user pivots the actuating lever 130 in a direction opposite the arrows on FIG. 13 to move the fingers 158 of the hinge plates 128 downward in the housing and thereby pivot the hinge plates in the direction opposite the arrow on FIG. 13. This pivoting of the actuating lever 130 attempts to move the travel bar 170 to the left (as oriented in FIG. 13A). However, the hinge plates 128 have not been pivoted substantially so that this movement is initially prevented. The travel bar 170 is able to resiliently bend at the hinge region 178 so that the travel bar effectively contracts in length, but more importantly permits continued pivoting movement of the lever 130. Therefore, the hinge plates 128 are able to pivot down while the travel bar 170 remains essentially stationary. When the hinge plates 128 move down far enough to clear the inclined shoulders 174 of the locking elements 172, the resiliency of the hinge region 178 of the travel bar urges the travel bar and locking elements to a locking position behind the hinge plates as shown in FIG. 13. The tips 184 engage the hinge plates 128 at the edges of the openings 176 to limit the leftward movement of the travel bar 170 and hold the travel bar in a slightly deformed configuration to prevent movement of the travel bar in the closed and locked position.

Because the locking elements 172 block movement of the hinge plates 128 to open the rings 104, there is less concern about loss of spring force applied to the hinge plates 128 by the housing resulting from plastic deformation of the housing associated with repeated opening and closing of the rings 104. Also, because the lateral sides 150 are spaced from one another a distance that is almost equal to the distance between the outer edge margins 156 of the interconnected hinge plates 128 there is little spring force exerted by the housing 102, which means the housing 102 does not undergo much deformation during opening and closing of the rings 104, thereby reducing the likelihood of plastic deformation of the polymeric housing 102. Further, the various features of the ring binder mechanism 100 in combination obviate the need to provide other spring members to bias the hinge plates to their open and/or closed position, thereby reducing the cost of making the ring mechanism.

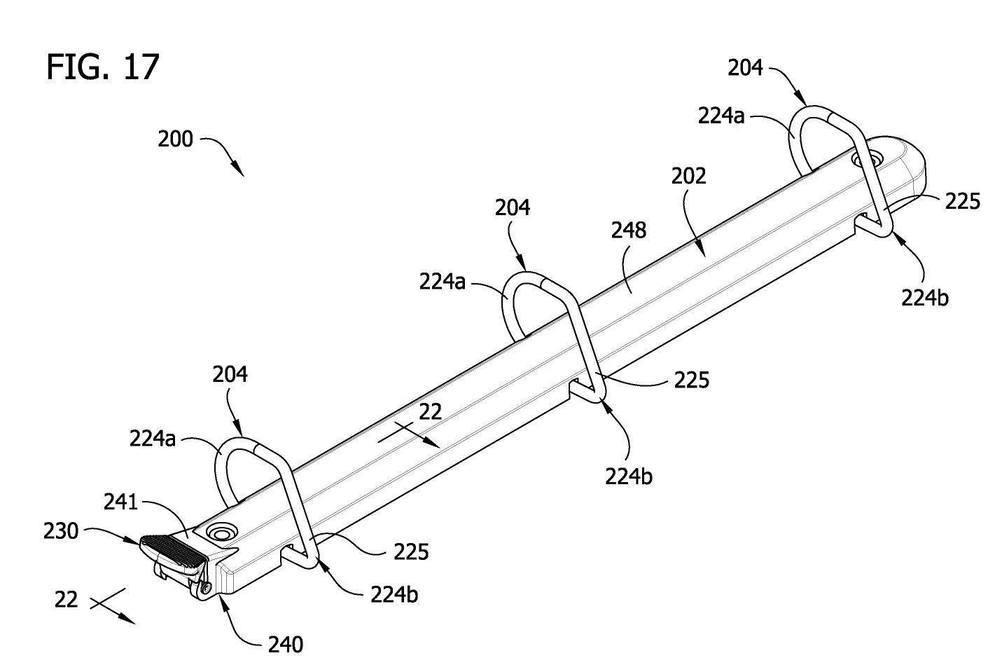

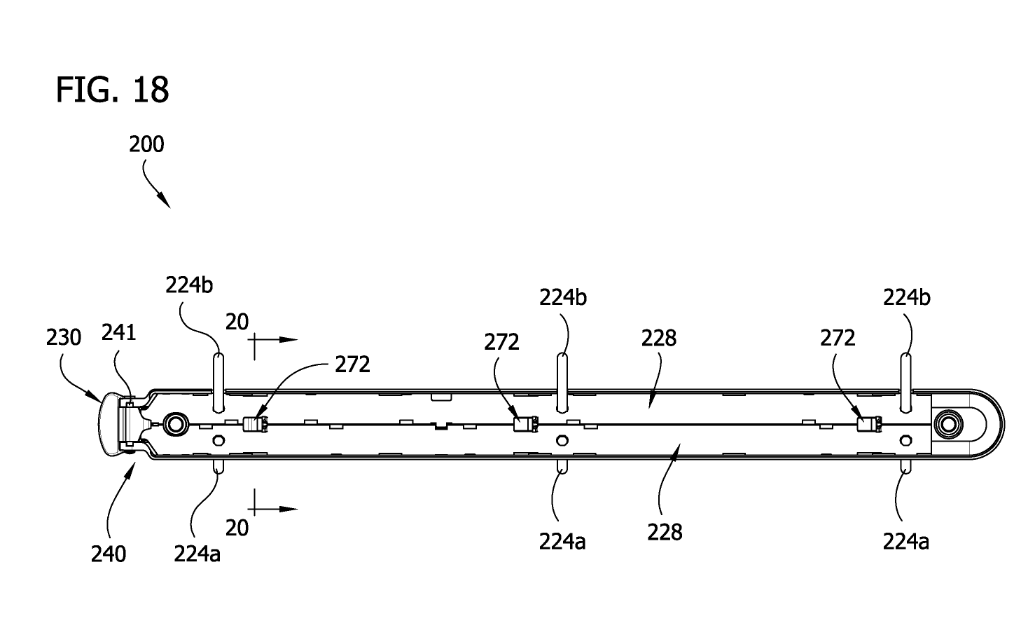

FIG. 17 illustrates a second embodiment of a ring binder mechanism, generally designated 200. Except as noted, the ring binder mechanism 200 is substantially the same as the ring binder mechanism 100 described above. One difference is that one ring member 224a of each of the rings 204 has a generally semi-circular shape while the other ring member 224b in the pair has a substantially straight inclined segment 225 and extends farther laterally away from the housing 202 than the semi-circular ring member. Further, in contrast the semi-circular ring members 224a, the ring members 224b that have the substantially straight segments 225 wrap around the outer edge margins 256 of the hinge plates 228 and extend upward to the hinge plates from beneath the hinge plates. Those skilled in the art will recognize that the rings 204 may be characterized as “D” shaped rings.

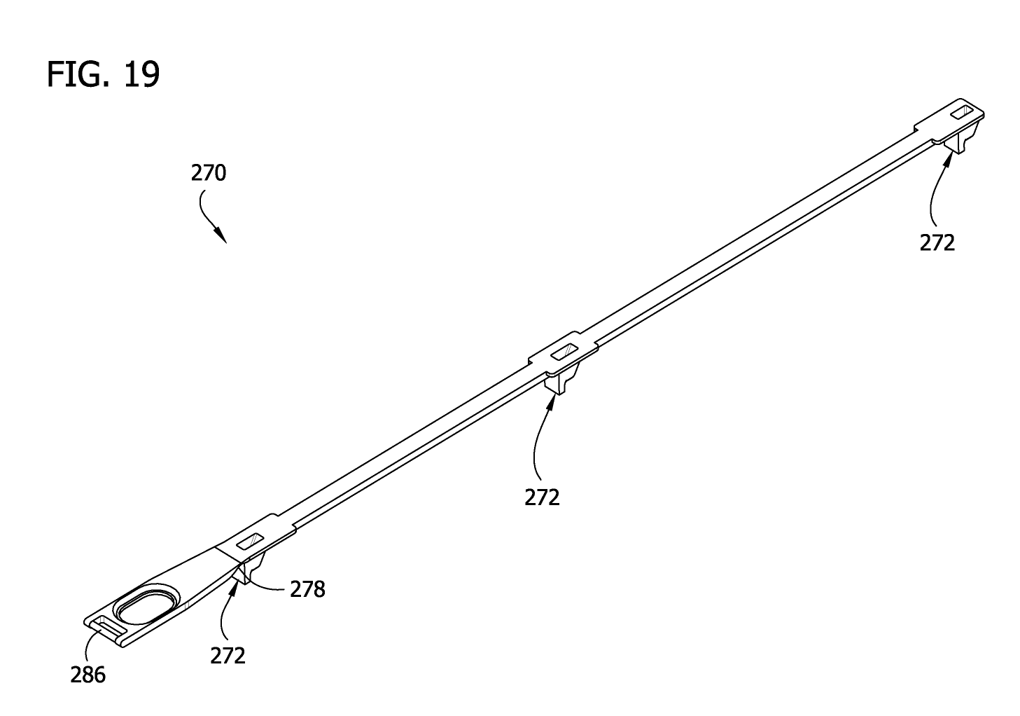

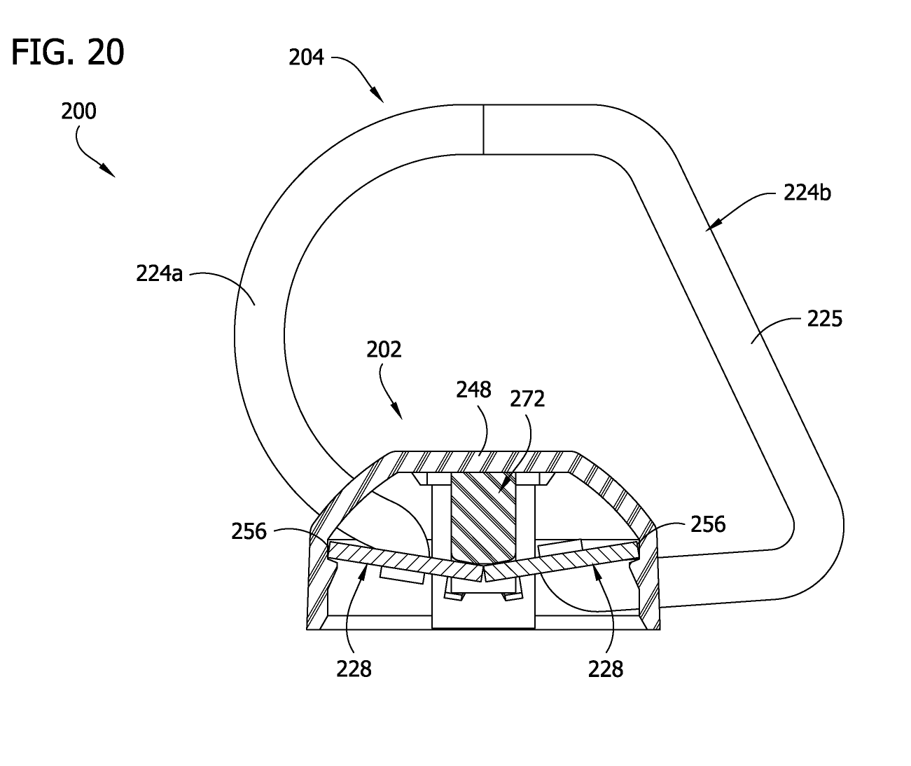

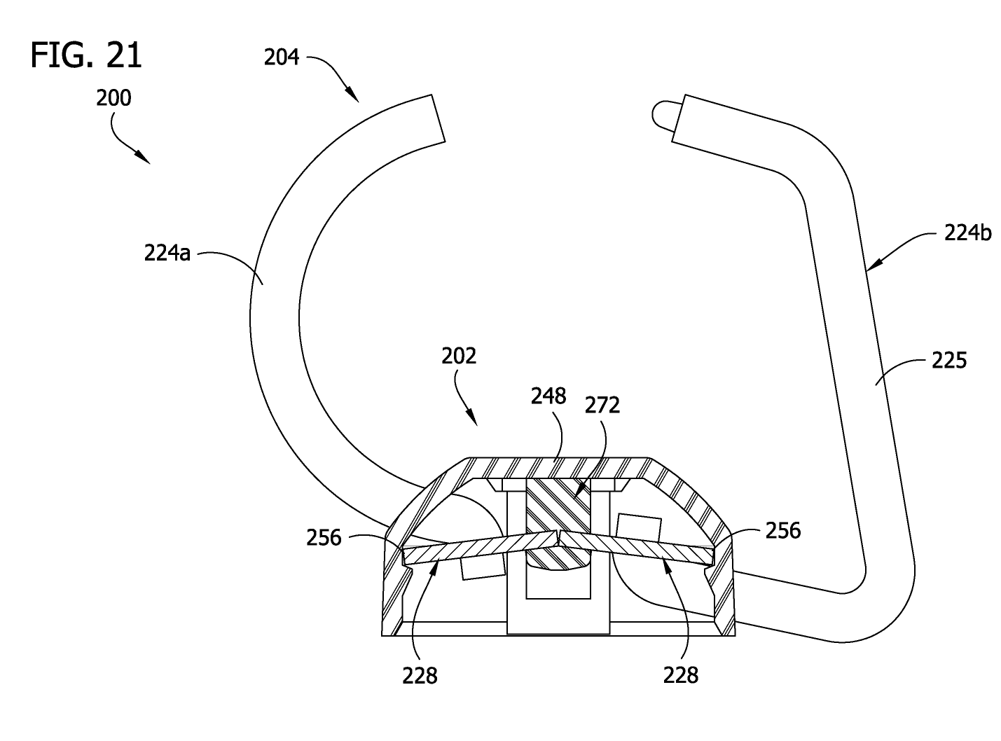

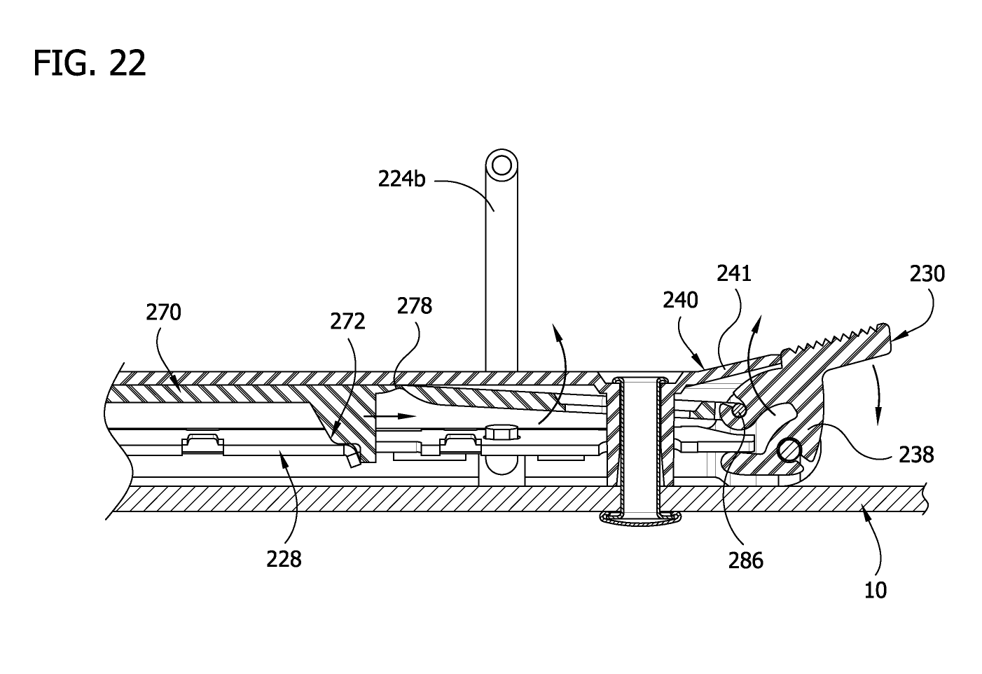

Referring to FIGS. 19 and 22, the travel bar 270 of the second embodiment is slightly different from the travel bar 170 described above. In particular, the travel bar 270 has a hinge region 278 comprised of a reduced thickness segment adjacent the locking element 272 that is closest to the handle 286. The travel bar 270 may bend at the hinge region 278 upon closing the ring members 224a, 224b to delay movement of the locking elements 272 while the hinge plates 228 pivot. Referring to FIG. 22, for example, the actuating lever 230 of the second embodiment 200 has a different configuration from the actuating lever 130 described above (FIG. 13) and has a living hinge 238 that deforms to accomplish the same function as the living hinge 138 of the first embodiment 100. The actuating lever 230 is constructed and arranged so that the ring members 224a, 224b, can be opened by pushing down on the lever in the manner of a push button. Also illustrated in FIG. 22, the mounting formation 241 at the end 240 of the housing 202 angles up from the central portion 248 of the housing to the end of the housing. This provides additional room in the housing 202 at the end 240 to facilitate upward pivoting movement of the segment of the travel bar 270 between the handle 286 and the hinge portion 278 upward in the housing as the actuating lever 230 is used to open the rings 204.

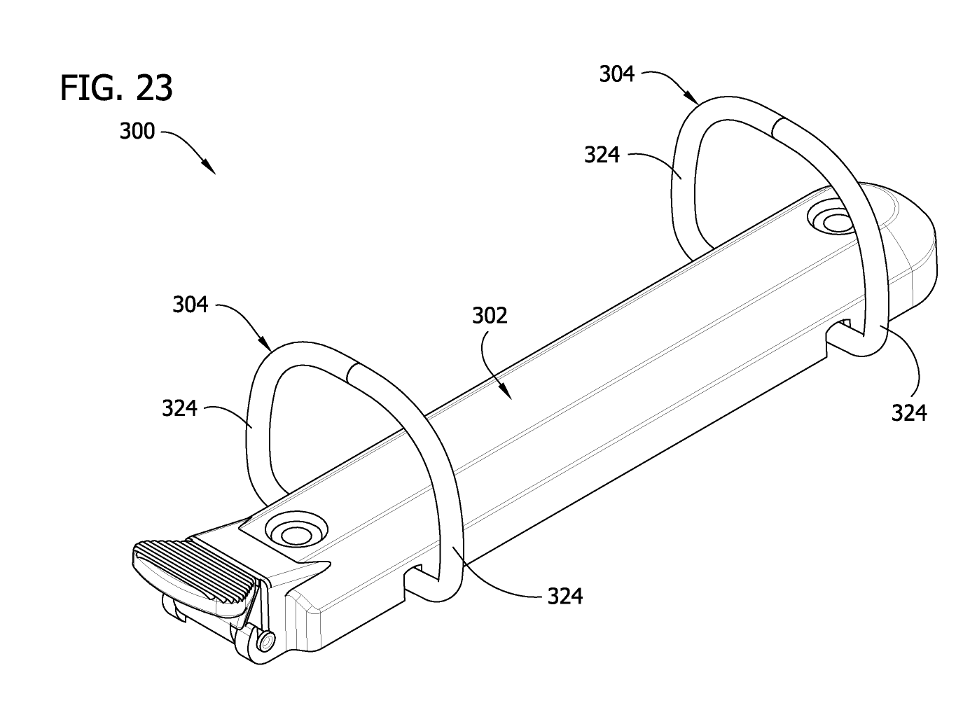

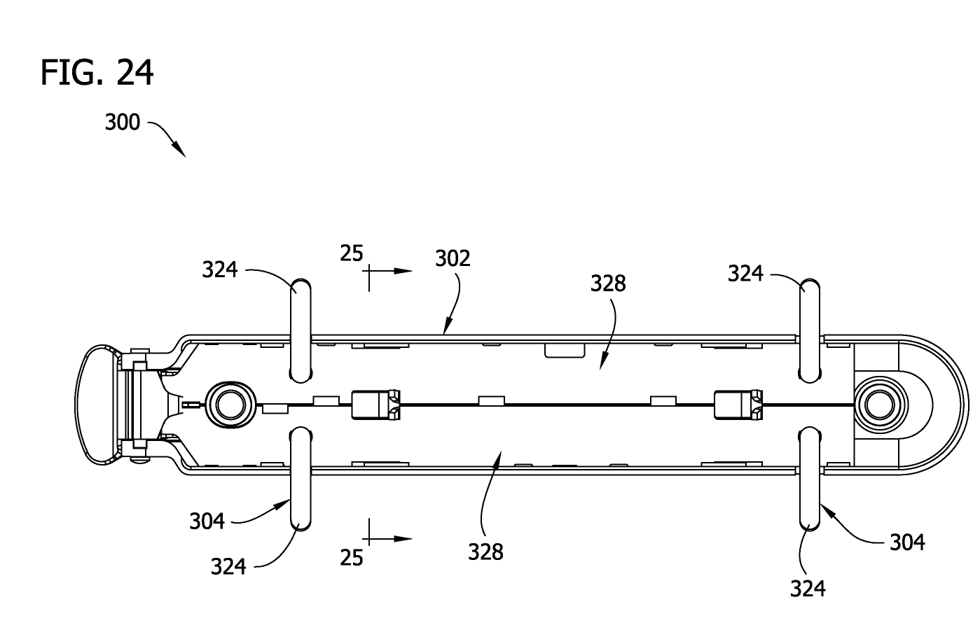

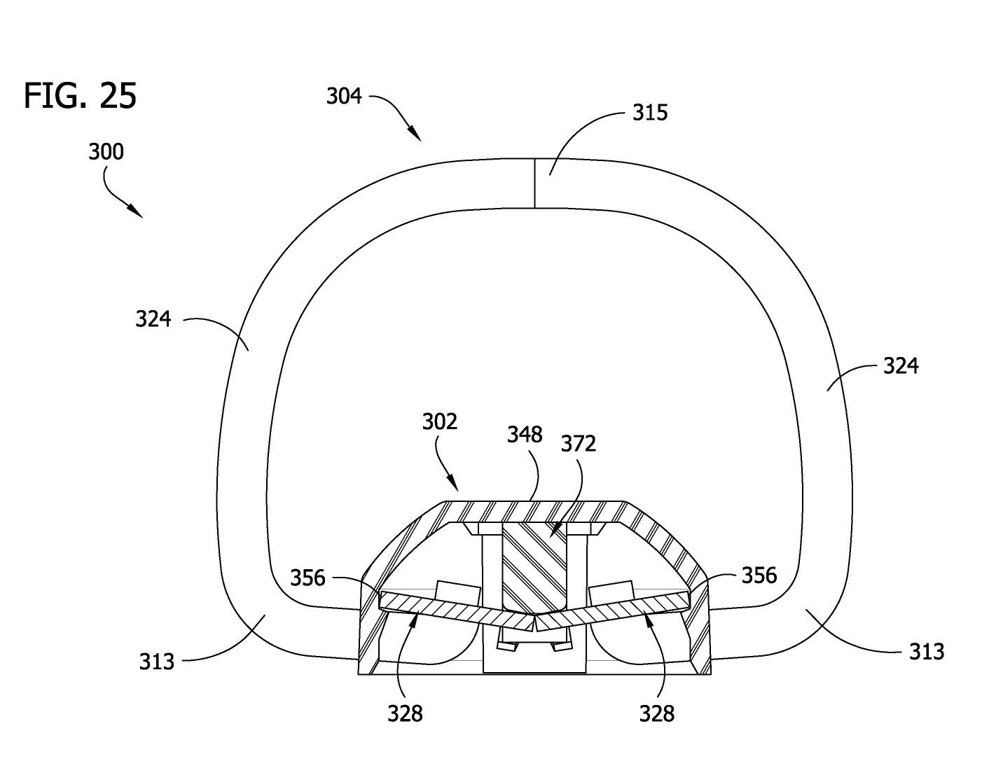

FIGS. 23-25 illustrate a third embodiment of a ring binder mechanism of the present invention, generally designated 300, which is substantially similar to the ring binder mechanism 200 described above except as noted. One difference is that the housing 302 and hinge plates 328 are substantially shorter than their counterparts in the embodiment 200 described above. Also, the ring binder mechanism 200 has only two rings 304 instead of three as in the previous embodiments 100, 200. As best viewed in reference to FIG. 25, the ring members 324 of each of the rings 304 are symmetric with one another. Each of the ring members 324 wraps around the outer edge margin 356 of the hinge plate 328 to which it is secured and extends upward to the hinge plate from beneath the hinge plate. The ring members 324 extend laterally outward from the housing 302 to a relatively sharp upward bend 313. The ring members 324 curve gradually inward extending up from the bend 313 and define a relatively flat upper portion 315 of the rings 304.

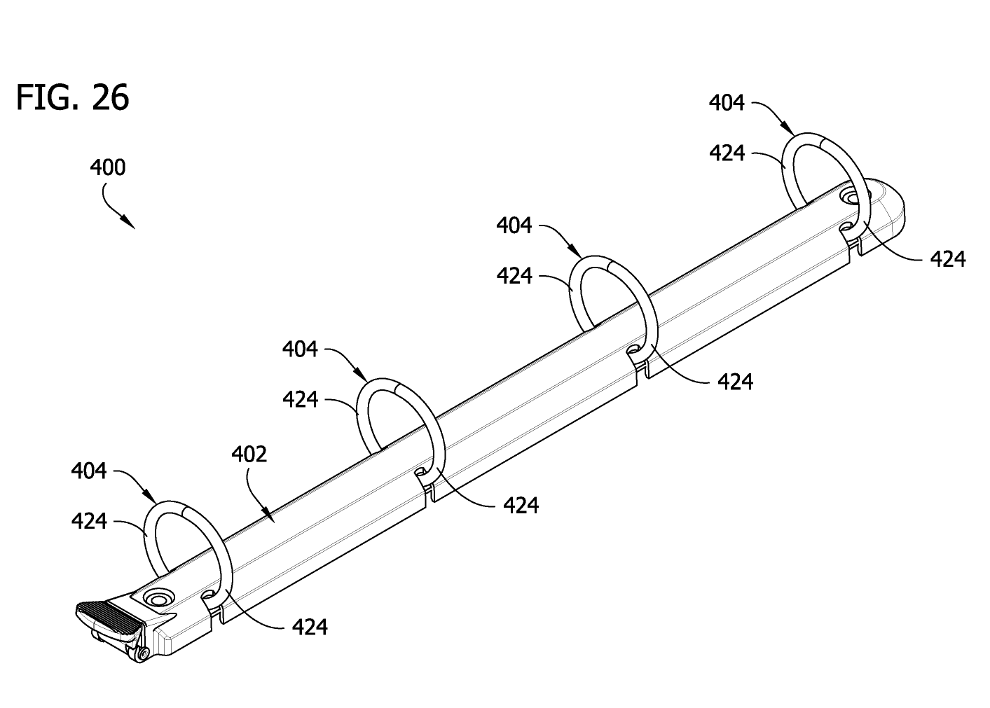

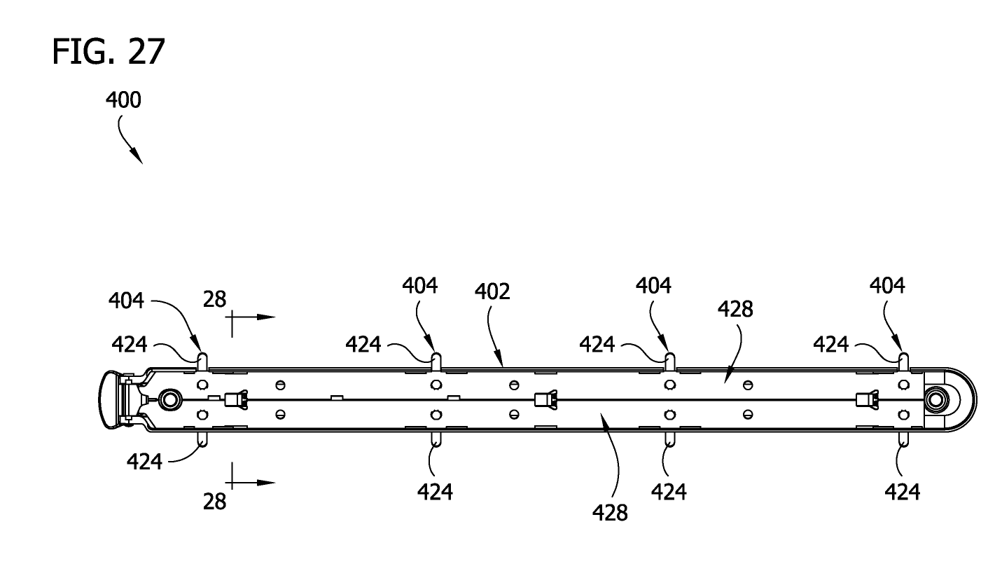

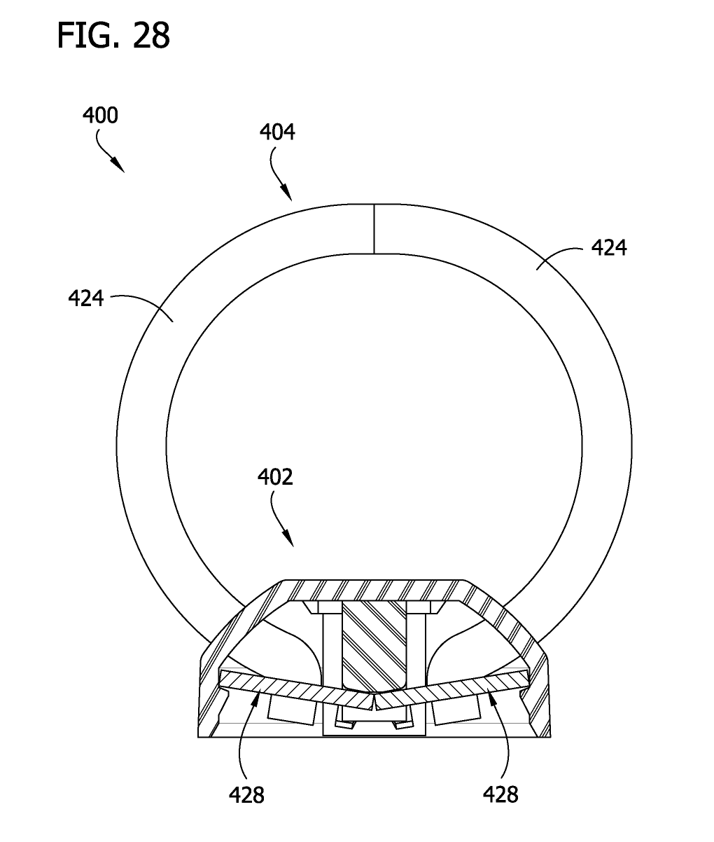

FIGS. 26-28 illustrate a fourth embodiment of a ring binder mechanism of the present invention, which is generally designated 400. This embodiment 400 is substantially the same as the second 200 and third 300 embodiments, except as noted. One difference is that this embodiment has a relatively longer housing 402 and relatively longer hinge plates 428. Further, the mechanism 400 includes four rings 404, in contrast to the embodiments 100, 200, 300 described above which have only two or three rings each. The rings 404 are formed by ring members 424 that are substantially similar in shape to the ring members 124 described for the first embodiment 100. Accordingly, the rings 404 have a generally circular appearance, as illustrated in FIG. 28.

When introducing elements of the ring binder mechanisms herein, the articles “a”, “an”, “the” and “said” are intended to mean that there are one or more of the elements. The terms “comprising”, “including” and “having” and variations thereof are intended to be inclusive and mean that there may be additional elements other than the listed elements. Moreover, the use of “upward” and “downward” and variations of these terms, or the use of other directional and orientation terms, is made for convenience, but does not require any particular orientation of the components.

As various changes could be made in the above without departing from the scope of the invention, it is intended that all matter contained in the above description and shown in the accompanying drawings shall be interpreted as illustrative and not in a limiting sense.

1-16. (canceled)

17. A ring binder mechanism for holding loose-leaf pages, the mechanism comprising:
an elongate housing constructed of a polymeric material and having a central portion and lateral sides extending downwardly along either side of the central portion;
a ring support disposed between the lateral sides of the polymeric housing and supported thereby for movement relative to the housing;
a plurality of rings for holding the loose-leaf pages, each ring including a first ring member and a second ring member, the first ring member being mounted on the ring support for movement with the ring support relative to the housing between a closed position and an open position, in the closed position the first and second ring members forming a substantially continuous, closed loop for allowing loose-leaf pages retained by the rings to be moved along the rings from one ring member to the other, and in the open position the first and second ring members forming a discontinuous, open loop for adding or removing loose-leaf pages from the rings;
a control structure movable relative to the housing for producing the movement of the ring support, the control structure being adapted to releasably lock the first member in the closed position by blocking movement of the ring support that moves the ring members to said opened position, the control structure comprising a travel bar moveable in translation relative to the housing, the travel bar including a locking element for engagement with the ring support to block movement of the ring support.

18. A ring binder mechanism as set forth in claim 17 wherein the travel bar is formed of a polymeric material.

19. A ring binder mechanism as set forth in claim 18 wherein the travel bar comprises plural locking elements, the locking elements being formed as one piece of polymeric material with the travel bar.

20. A ring binder mechanism as set forth in claim 19 wherein the travel bar comprises an elongate bar extending a majority of the length of the travel bar and pads spaced along the length of the elongate bar and disposed for slidably engaging the housing, the pads having a width greater than a width of the elongate bar.

21. A ring binder mechanism as set forth in claim 20 wherein the locking elements are disposed along the elongate bar at positions coinciding with positions of the pads.

22. A ring binder mechanism as set forth in claim 18 wherein the travel bar includes a hinge region adapted to bend about an axis transverse to the lengthwise extension of the travel bar.

23. A ring binder mechanism as set forth in claim 22 wherein the hinge region has a thickness that is less than a thickness of the travel bar adjacent to the hinge region on opposite ends thereof.

24. A ring binder mechanism as set forth in claim 23 wherein the hinge region is curved in a direction lengthwise of the travel bar, the hinge region curving away from the housing.

25. A ring binder mechanism as set forth in claim 24 wherein the hinge region has an elongate opening therein.

26. A ring binder mechanism as set forth in claim 18 wherein the ring support comprises a pair of metal hinge plates in generally side-by-side relation and hingedly connected to one another for pivoting movement relative to each other, the metal hinge plates having lengths greater than one half a length of the housing.

27. A ring binder mechanism as set forth in claim 26 wherein the hinge plates define an opening for receiving the locking element in the open position of the first ring member.

28. A ring binder mechanism as set forth in claim 26 wherein the control structure comprises a lever pivotally mounted on the housing generally at a longitudinal end thereof, at least one of the hinge plates including a finger projecting lengthwise of the hinge plate from an end of the hinge plate and captured by the lever for transferring force from the lever to the hinge plates.

29. A ring binder mechanism as set forth in claim 28 wherein the lever is mounted by a metal hinge pin on the housing.

30. A ring binder mechanism as set forth in claim 17 wherein the housing is formed with tubes projecting from the housing for receiving fasteners for connecting the housing to another structure.

31. A ring binder mechanism as set forth in claim 17 in combination with a cover, the ring binder mechanism being mounted on the cover, the cover being hinged for movement to selectively cover and expose any loose leaf pages held by the ring binder mechanism.
